(19) United States
(12) Patent Application Publication
(10) Pub. No.: US 2007/0041215 A1
(43) Pub. Date: Feb. 22, 2007

(54) Backlight module and light guide plate therein and method for diminishing corner shadow area

(75) Inventors: Ko-Chia Kao, Ping Tung Hsien (TW); Jing-Huan Liao, Taoyuan City (TW); Chih-Kuang Chen, Kaohsiung (TW); Jyh-Haur Huang, Pingtung Hsien (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/378,487

(22) Filed: Mar. 20, 2006

(30) Foreign Application Priority Data
Aug. 17, 2005 (TW) 94128092

(51) Int. Cl. F21V 7/04

(52) U.S. Cl. 362/620; 362/603; 362/626

(57) ABSTRACT

A backlight module is provided. The backlight module includes a light guide plate, a lamp and an optical microstructure. The light guide plate has an edge side. The lamp is disposed on the edge side of the light guide plate. The lamp has an electrode end. The light guide plate has a corner shadow area adjacent to the corner shadow area. Light generated by the lamp propagates toward the edge side in the first direction. The optical microstructure is disposed on a surface of the edge side of the light guide plate and guides the light toward the second direction to enter the corner shadow area.

### BACKGROUND OF THE INVENTION

(1) Field of the Invention

The present invention generally relates to an edge-type backlight module, a manufacturing method thereof and a light guide plate within the backlight module.

(2) Description of the Prior Art

A non-luminous display panel, such as a liquid crystal panel, usually needs a backlight source to display an image. In the prior art of the backlight sources, the edge-type backlight module meets the demand of thinning the products.

Please refer to FIG. 1A and FIG. 1B. FIG. 1A and FIG. 1B illustrate a lamp 10 and a light guide plate 20 of a conventional backlight module. FIG. 1A is a top view of the lamp 10 and the light guide plate 20. FIG. 1B is a sectional side view of the lamp 10 and the light guide plate 20. The lamp 10 is disposed on an edge side 201 of the light guide plate 20 in the so-called edge-type backlight module. Light diffuses in the light guide plate 20 due to total internal reflection and emits out from the light guide plate 20 through a light emitting surface 202. The light is provided for a display panel (not shown in FIG. 1A and FIG. 1B).

The area of the light emitting surface 202 is substantially the same as that of the display panel. Theoretically, the light emitting surface 202 of the light guide plate 20 should provide an uniform surface light source for the display panel. However, “corner shadow areas” (reference numbers 21 and 22 in FIG. 1A) usually occur practically when the light is observed from the light emitting surface 202. As a result, the uniformity of the light provided by the backlight module is decreased.

Corner shadow areas 21 and 22 occur due to non-luminous areas 11 and 12 of the lamp 10. The non-luminous areas 11 and 12 are formed near electrode end ends 101 and 102 of the lamp 10. The non-luminous areas 11 and 12 are formed mainly because of two reasons: one is the obstructing of the bushings of the electrode ends, and the other is the weaker luminous part of the lamp 10 itself.

The bushings of the electrode ends are made of insulated material, for covering and protecting the electrode ends 101 and 102 of the lamp 10. Because the mechanism designs of different kinds of backlight modules are not the same, sometimes the bushings of the electrode ends obstruct the light of the lamp 10, affecting the light propagating into the light guide plate 20. Therefore, the corner shadow areas 21 and 22 occur.

Besides, the luminance of part of the lamp 10 adjacent to the electrode ends 101 and 102 is weaker originally. Generally speaking, when the luminance of a part of the lamp 10 is lower than 80% of the brightest luminance of the lamp 10, the part of the lamp 10 is defined as a non-luminous area (such as reference numbers 11 and 12 in FIG. 1A).

Please refer to FIG. 1C, it is a bottom view of the lamp 10 and the light guide plate 20 in FIG. 1A. A conventional method for diminishing corner shadow areas 21 and 22 is to increase the size or the density of an optical pattern 23 on a bottom surface 204 of the light guide plate 20. The optical pattern 23 is disposed on the bottom surface 204 of the light guide plate 20, for enabling the diffusing light in the light guide plate 20 to be reflected toward the light emitting surface 202 (shown in FIG. 1A). The conventional optical pattern 23 has many other kinds of embodiments in addition to the circle type optical pattern in FIG. 1C.

Enlarging the size of the optical pattern 23 in the corner shadow area 21 (as shown in FIG. 1C) or increasing the density of the optical pattern 23 in the corner shadow area 21 (not shown in FIGS.) can increase the luminance of the corner shadow area 21. However, the improvement is limited because the light passing through the corner shadow area 21 is quite a little.

Moreover, applying v-cut technology to form the optical patterns has gradually become the main trend recently. The v-cut technology is to perform an one-time cutting on the bottom surface 204 of the light guide plate 20 by a specific cutter to form the needed optical patterns on the whole bottom surface 204. The v-cut technology is convenient and easy. However, it is difficult to increase the size or the density of the optical patterns on part of the bottom surface 204 by the v-cut technology. Therefore, the above method for diminishing the corner shadow areas 21 and 22 can not be applied to the v-cut type light guide plate 20.

Another conventional method for diminishing the corner shadow areas is to adhere a reflection film 25 or to spread reflection material on the surface of the edge side of the light guide plate 20 corresponding to the corner shadow areas 21 and 22. The purpose is to avoid the light diffusing from the corner shadow areas 21 and 22. As a result, the luminance of the corner shadow areas 21 and 22 is increased. Please refer to Republic of China patent no. 493055. However, as described above, because the light passing through the corner shadow areas 21 and 22 is quite a little, the improvement is limited. Moreover, the reflection film 25 or the reflection material may also decrease the light entering into the corner shadow areas 21 and 22 from the lamp 10. Therefore, this prior art has its limitation.

According to the shortness of the above prior art, it is necessary to provide a practical and effective solution to diminish the corner shadow area of the light guide plate in the edge-type backlight module.

### SUMMARY OF THE INVENTION

An objective of the present invention is to provide an edge-type backlight module for diminishing the corner shadow area.

An edge-type backlight module, a light guide plate therein and a method for diminishing a corner shadow area are provided by the present invention.

The backlight module provided by the present invention includes a light guide plate, a lamp and a optical microstructure. The light guide plate has an edge side. The lamp is disposed on the edge side of the light guide plate. The lamp has an electrode end. The light guide plate has a corner shadow area adjacent to the electrode end. Light generated by the lamp propagates toward the edge side in the first direction. The optical microstructure is disposed on a surface of the edge side. The optical microstructure guides the light toward the second direction to enter the corner shadow area.

The present invention provides a fundamental method to solve the problem of the corner shadow area. The present invention utilizes the optical microstructure to change the propagating direction of the light. As a result, the quantity of light entering the corner shadow area is increased, so that the problem is solved fundamentally.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1A is a top view of a lamp and a light guide plate of a conventional backlight module.

FIG. 1B is a cross-sectional view of the lamp and the light guide plate in FIG. 1A.

FIG. 1C is a bottom view of the lamp and the light guide plate in FIG. 1A.

FIG. 2A is a top view of a light guide plate and a lamp of a backlight module according to the present invention.

FIG. 2B is a partial enlarged view of the FIG. 2A.

FIG. 3 is a three dimensional exploded view of the backlight module according to the present invention.

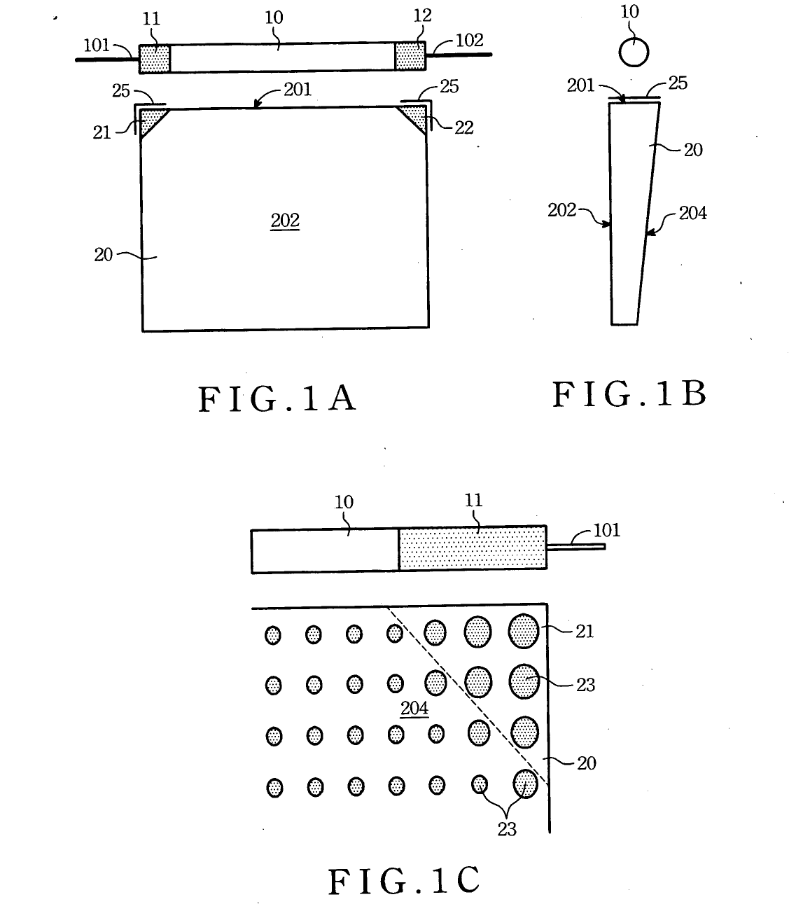

### DESCRIPTION OF THE PREFERRED EMBODIMENT

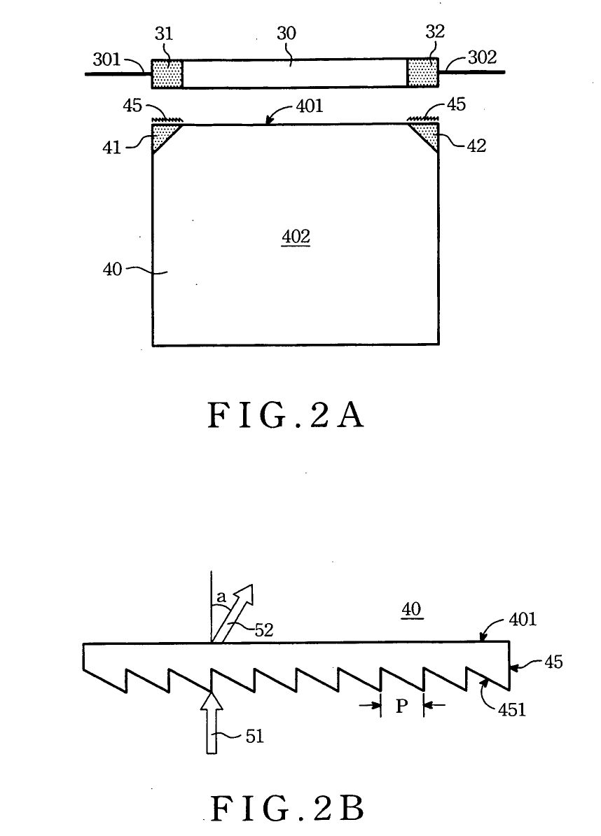

Please refer to FIG. 2A. FIG. 2A is a top view of a light guide plate and a lamp of a backlight module according to the present invention. The backlight module 3 includes a lamp 30 and a light guide plate 40. The light guide plate 40 has an edge side 401 and a light emitting surface 402. The lamp 30 is disposed on the edge side 401. Light generated by the lamp 30 diffuses inside the light guide plate 40 due to total internal reflection and emits out from the light guide plate 40 through the light emitting surface 402. The light is provided for a display panel (not shown in FIG. 2A).

The lamp 30 has two electrode ends 301 and 302. The lamp 30 of the embodiment shown in FIG. 2A is tube-shaped, and the electrode ends 301 and 302 are disposed respectively on two ends of the lamp 30. However, the lamp 30 can be shaped in any other form. Thus, the electrode ends 301 and 302 can be disposed on the same side of the lamp 30 as well. Due to the obstructing of the bushings of the electrode ends, or the weaker luminous part of the lamp 30 itself, there are non-luminous areas 31 and 32 adjacent to the electrode ends 301 and 302.

When the light generated by the lamp 30 is observed from the light emitting surface 402, corner shadow areas 41 and 42 occur in the light guide plate 40 because of the non-luminous areas 31 and 32 of the lamp 30. In the present invention, the backlight module 3 further includes a optical microstructure 45. The optical microstructure 45 is disposed on a surface of the edge side 401 to diminish the corner shadow areas 41 and 42. The optical microstructure 45 changes the propagating direction of the light to increase the quantity of the light entering the corner shadow areas 41 and 42. Therefore, the luminance of the corner shadow areas 41 and 42 is increased, for diminishing the corner shadow areas 41 and 42. Providing a method for diminishing the corner shadow areas 41 and 42 is an important objective of the present invention. In practice, the optical microstructure 45 includes prism, micro-prism, or fresnel lens.

Please refer to FIG. 2B. FIG. 2B is a partial enlarged view of the FIG. 2A. The operating method of the optical microstructure 45 is illustrated in FIG. 2B. The light generated by the lamp 30 propagates toward the edge side 401 of the light guide plate 40 in the first direction 51. The optical microstructure 45 guides the light toward the second direction 52. Accordingly, at least part of the light propagating in the second direction 52 enters the corner shadow areas 41 and 42 shown in the FIG. 2A. As a result, the quantity of the light entering the corner shadow areas 41 and 42 is increased. An angle (reference number “a” in FIG. 2B) between the first direction 51 and the second direction 52 is substantially greater than 0 degree and less than 90 degree. In a preferred embodiment, the first direction 51 and the second direction 52 forms an angle ranging from about 15 degree to about 25 degree, substantially equal to 20 degree.

Moreover, the light generated by the lamp 30 does not propagate in a single direction. As the general comprehension of light propagation, light propagates in different directions. Therefore, the above first direction is not limited to the normal direction of the edge side 401 of the light guide plate 40 shown in FIG. 2B. The first direction 51 in FIG. 2B is only one of the propagating directions of the light generated by the lamp 30. Despite the actual incident angle of the first direction 51, the optical micro structure 45 can change the propagating direction of the light. The changed angle ranges from about 0 degree to about 90 degree in all embodiments of the present invention. For example, the changed angle is greater than 0 degree and not greater 10 degree; greater than 10 degree and not greater 20 degree; greater than 20 degree and not greater 30 degree; greater than 30 degree and not greater 40 degree; greater than 40 degree and not greater 50 degree; greater than 50 degree and not greater 60 degree; greater than 60 degree and not greater 70 degree; greater than 70 degree and not greater 80 degree; greater than 80 degree and not greater 90 degree; greater than 5 degree and not greater 15 degree; greater than 15 degree and not greater 25 degree; greater than 25 degree and not greater 35 degree; greater than 35 degree and not greater 45 degree; greater than 45 degree and not greater 55 degree; greater than 55 degree and not greater 65 degree; greater than 65 degree and not greater 75 degree; greater than 75 degree and not greater 85 degree.

As shown in FIG. 2B, the optical microstructure 45 includes several micro prisms 451. The present invention utilizes the principle that a prism refracts light. However, there is no space for disposing conventional prisms between the lamp 30, and the edge side 401 of the light guide plate 40. Therefore, the tiny micro prisms 451 are made by micrometer scale technology or nanometer scale technology to refract the light in the present invention.

The distance between each of the micro prisms 451 can be the same or different in different embodiments of the present invention. However, for the convenience of the manufacturing process, periodic micro prisms 451 of the optical microstructure 45 are substantially arranged in a predetermined distance “p” as shown in FIG. 2B practically. In another embodiment of the present invention, the micro prisms 451 of the optical microstructure 45 have about the same height. Part of the micro prisms 451 adjacent to the non-luminous areas 31 and 32 has a smaller predetermined distance “p”, while another part of the micro prisms 451 adjacent to the luminous areas of the lamp 30 has a longer predetermined distance “p”. However, the optical microstructure 45 is not limited thereto. As long as the optical microstructure 45 able to guide the light to enter the corner shadow areas meets the requirement of the present invention.

In several embodiments provided by the present invention, the above predetermined distance “p” is between 10 μm and 20 μm, 20 μM and 30 μm, 30 μm and 40 μm, 40 μm and 50 μm, 50 μm and 60 μm, 60 μm and 70 μm, 70 μm and 80 μm, 80 μm and 90 μm, 90 μm and 100 μm, 5 μm and 15 μm, 15 μm and 25 μm, 25 μm and 35 μm, 35 μm and 45 μm, 45 μm and 55 μm, 55 μm and 65 μm, 65 μm and 75 μm, 75 μm and 85 μm or 85 μm and 95 μm. The above are practical embodiments of the present invention. As stated above, the range of the predetermined distance “p” can be between 10 μm and 100 μm.

In an embodiment of the present invention, the optical microstructure 45 is formed integrally on the surface of the edge side 401 of the light guide plate 40. The optical microstructure 45 can be formed by direct injection molding, heat press molding or film adhering. In another embodiment of the present invention, the optical microstructure 45 is a light guiding film. The light guiding film is adhered on the surface of the edge side 401 of the light guide plate 40. And the light guiding film can be adhered by an optical adhesive.

The optical microstructure 45 is disposed on the surface of the edge side 401 of the light guide plate 40. However, the optical microstructure 45 does not need to be disposed all over the surface of the edge side 401. Practically, the optical microstructure 45 is disposed on part of the surface of the edge side 401 corresponding to the corner shadow areas 41 and 42. The width of the optical microstructure 45 depends on the actual range of the corner shadow areas 41 and 42. Before the optical microstructure 45 is disposed on the surface of the edge side 401, the range of the corner shadow areas 41 and 42 can be detected in advance. The range of the corner shadow areas 41 and 42 can be detected by an optical measurement instrument, such as TOPCON BM-7. Or, the range of the corner shadow areas 41 and 42 can be observed by eyes. As a result, the position of the optical microstructure 45 can be determined.

In the embodiment of the present invention as shown in FIG. 2A, the corner shadow areas 41 and 42 are disposed on different sides of the light guide plate 40. Therefore, the optical microstructure 45 on the surface of the corner shadow areas 41 and 42 are disposed in different directions, so that the light is guided toward the corner shadow areas 41 and 42 respectively on different sides of the light guide plate 40 to increase the luminance.

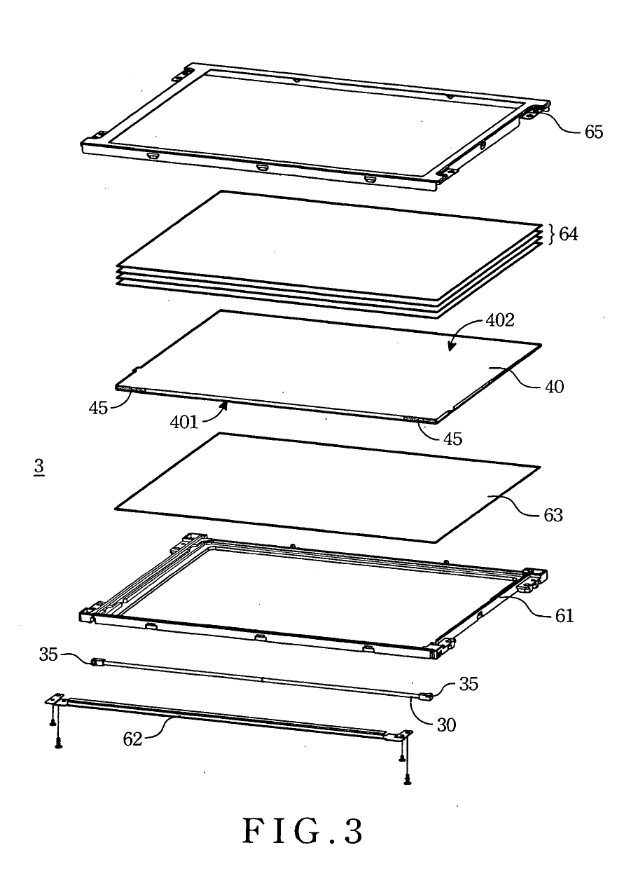

Please refer to FIG. 3. FIG. 3 is a three dimensional exploded view of the backlight module according to the present invention. Other components of the backlight module according to the present invention are illustrated in FIG. 3. The backlight module 3 further includes a base 61, a lamp cover 62, a reflector 63, several optical films 64 and an upper frame 65. The optical microstructure 45 is disposed on the surface of the edge side 401 of the light guide plate 40. And the bushings of the electrode ends 35 are disposed on the two electrode ends of the lamp 30.

The base 61 is used for containing all the components of the backlight module 3. The reflector 63 is disposed on the base 61 and under the light guide plate 40. The lamp 30 is disposed on the edge side 401 for providing the light guide plate 40 with the light. The lamp cover 62 covers part of the lamp 30 which is not relative to the edge side 401, for protecting the lamp 30. Reflection material can be spread inside the lamp cover 62, or a reflection film can be disposed inside the lamp cover 62 in order to increase the efficiency of the light. The reflector 63 is also used for increasing the efficiency of the light of the whole backlight module 3.

Several optical films 64 are disposed on the light emitting surface 402 of the light guide plate 40. The optical films 64 can include an upper brightness enhancement film, a lower brightness enhancement film, an upper diffusion film and a lower diffusion film, for enhancing the quality of the light provided by the backlight module 3. Above the optical films 64, the upper frame 65 combines the base 61 to compose the backlight module 3.

As stated above, a backlight module, a light guide plate and a method for diminishing a corner shadow area are provided by the present invention. The problem of the corner shadow area affects the backlight module a lot. And a fundamental solution of the problem is carried out by the present invention. In any prior art, the quantity of the light entering the corner shadow area is insufficient originally. Therefore, the method of increasing the size or the density of the optical patterns on the bottom surface of the light guide plate has its limitation. The method of adhering a reflection film on the corner shadow area is limited as well. The present invention utilizes the optical microstructure to increase the quantity of the light entering the corner shadow area to solve the problem fundamentally.

The reason why the corner shadow area occurs is illustrated as above. It is mainly because the obstructing of the bushing of the electrode end and the weaker luminous part of the lamp itself. Both of them can be different due to the mechanism design of the backlight module. Therefore, the range of different corner shadow areas in different backlight modules are not the same. The method for diminishing the corner shadow area can adjust the width and the location of the optical microstructure according to the detected range of the corner shadow area. Practically, a light guiding film can be adhered to diminish the corner shadow area. Therefore, the present invention can be applied to all kind of backlight modules and light guide plates. And as to the business, the present invention brings tremendous convenience in application.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A backlight module, comprising:
a light guide plate having an edge side;
a lamp, disposed on the edge side, for emitting light toward the edge side in a first direction; and
an optical microstructure, disposed on a surface of the edge side, for guiding the light toward a second direction.

2. The backlight module of claim 1, wherein the lamp has an electrode end, the light guide plate has a corner shadow area adjacent to the electrode end, and at lease part of the light propagating in the second direction enters the corner shadow area.

3. The backlight module of claim 1, wherein the optical microstructure comprises a plurality of micro-prisms.

4. The backlight module of claim 1, wherein the first direction and the second direction form an angle ranging from about 0 degree to about 90 degree.

5. The backlight module of claim 1, wherein the first direction and the second direction form an angle ranging from about 15 degree to about 25 degree.

6. The backlight module of claim 3, wherein the micro-prisms have a pitch ranging from about 10 μm to about 100 μm.

7. The backlight module of claim 1, wherein the optical microstructure is a light guiding film adhering on the surface of the edge side of the light guide plate.

8. The backlight module of claim 1, wherein the optical microstructure is formed integrally on the surface of the edge side of the light guide plate.

9. The backlight module of claim 2, wherein the optical microstructure is disposed on the surface of the edge side of the light guide plate corresponding to the corner shadow area.

10. The backlight module of claim 1, wherein the light guide plate is a V-cut type light guide plate.

11. A light guide plate, adapted to an backlight module, the light guide plate comprising:
an edge side, wherein a lamp of the backlight module disposed on the edge side emitting light toward the edge side in a first direction; and
an optical microstructure, disposed on a surface of the edge side, for guiding the light toward a second direction.

12. A light guide plate of claim 11, wherein the lamp has an electrode end, the light guide plate having a corner shadow area adjacent to the electrode end, at least part of the light propagating in the second direction enters the corner shadow area, the optical microstructure disposed on the surface of the edge side of the light guide plate corresponding to the corner shadow area.

13. The light guide plate of claim 11, wherein the optical microstructure comprises a plurality of micro-prisms.

14. The light guide plate of claim 11, wherein the first direction and the second direction form an angle ranging from about 0 degree to about 90 degree.

15. The light guide plate of claim 11, wherein the first direction and the second direction form an angle ranging from about 15 degree to about 25 degree.

16. The light guide plate of claim 13, wherein the micro-prisms have a pitch ranging from about 10 μm to about 100 μm.

17. The light guide plate of claim 11, wherein the optical microstructure is a light guiding film adhering on the surface of the edge side of the light guide plate.

18. The light guide plate of claim 11, wherein the optical microstructure is formed integrally on the surface of the edge side of the light guide plate.

19. A method for diminishing a corner shadow area of a light guide plate, the light guide plate having an edge side with a lamp disposed thereon, light generated by the lamp propagating toward the edge side in a first direction, the lamp having an electrode end, the light guide plate having a corner shadow area adjacent to the electrode end, the method comprising:
locating the corner shadow area;
forming an optical microstructure on a surface of the edge side corresponding to the corner shadow area; and
guiding the light toward a second direction by the optical microstructure so that at least part of the light propagating in the second direction enters the corner shadow area.

20. The method of claim 19, wherein the optical microstructure is formed on the surface of the edge side of the light guide plate by direct injection molding, heat press molding, or adhering.
